(19) United States
(12) Patent Application Publication
(10) Pub. No.: US 2025/0126307 A1
(43) Pub. Date: Apr. 17, 2025

(54) METHOD, APPARATUS, ELECTRONIC DEVICE, MEDIUM AND PRODUCT FOR VIDEO BITRATE ADJUSTMENT

(71) Applicants: Douyin Vision Co., Ltd., Beijing (CN); Lemon Inc., Grand Cayman (KY)

(72) Inventors: Jing Liu, Beijing (CN); Bo Wang, Beijing (CN); Shu Shi, Los Angeles, CA (US)

(21) Appl. No.: 18/913,935

(22) Filed: Oct. 11, 2024

(30) Foreign Application Priority Data
Oct. 13, 2023 (CN) 202311331637.4

(51) Int. Cl. H04N 21/234; H04N 21/238

(52) U.S. Cl. CPC H04N 21/23418; H04N 21/238

(57) ABSTRACT

Embodiment of the disclosure disclose a method, apparatus, device, storage medium and product for video bitrate adjustment, and the method includes: analyzing and determining a current picture quality evaluation result of a target video stream in a current bitrate regulation period based on a video frame; and determining a target bitrate based on a predetermined target picture quality evaluation standard associated with a bitrate and/or a picture quality change trend of the current picture quality evaluation result relative to a historical picture quality evaluation result in a historical bitrate regulation period.

### CROSS-REFERENCE

The present application claims priority to Chinese Patent Application No. 202311331637.4, filed on Oct. 13, 2023, and entitled “METHOD, APPARATUS, ELECTRONIC DEVICE, MEDIUM AND PRODUCT FOR VIDEO BITRATE ADJUSTMENT”, the entirety of which is incorporated herein by reference.

### FIELD

Embodiments of the present disclosure relate to the technical field of video processing, in particular to a method, apparatus, electronic device, medium and product for video bitrate adjustment.

### BACKGROUND

In the video push-stream process, the size of the code bitrate determines the picture quality of the push-stream video, and also reflects the bandwidth cost of the video push-stream to a certain extent. In order to improve the quality of experience (QoE) of the video application, in the video push-stream process, reducing the picture lag of the push-stream video while making the push-stream video having higher picture quality is taken as a goal to perform the bitrate dynamic adjustment optimization.

However, currently, information such as a bandwidth estimation algorithm and a bit-table is mostly used to determine a target bitrate of the video push-stream. In this process, only network bandwidth adaptation is considered, and the picture quality is not adaptively considered in combination; moreover, a nonlinear relationship exists between the target bitrate and the picture quality perceived by the user, and it is difficult to achieve an optimization objective of bitrate adjustment.

### SUMMARY

The present disclosure provides a method, apparatus, electronic device, medium and product for video bitrate adjustment. The picture quality of video stream can be analyzed during the video push-stream process, and the target bitrate on the video push-stream side can be adjusted based on the picture quality evaluation result, thereby optimizing the video push-stream quality of experience when bandwidth permits.

According to a first aspect, the embodiments of the present disclosure provide a method of video bitrate adjustment, and the method includes:
analyzing and determining, based on a video frame, a current picture quality evaluation result of a target video stream in a current bitrate regulation period; and
determining a target bitrate based on a predetermined target picture quality evaluation standard associated with a bitrate and/or a picture quality change trend of the current picture quality evaluation result relative to a historical picture quality evaluation result in a historical bitrate regulation period.

According to a second aspect, the embodiments of the present disclosure further provide an apparatus for video bitrate adjustment, including:
a video quality analysis module configured to analyze and determine, based on a video frame, a first picture quality evaluation result of a target video stream in a current bitrate regulation period; and
a bitrate adjustment module configured to determine a target bitrate based on a predetermined target picture quality evaluation standard associated with a bitrate and/or a picture quality change trend of the first picture quality evaluation result relative to a second picture quality evaluation result in a historical bitrate regulation period.

According to a third aspect, the embodiments of the present disclosure further provide an electronic device, including:
one or more processors;
a storage device storing one or more programs, and the one or more programs, when executed by the one or more processors, causing the one or more processors to implement the method of video bitrate adjustment according to any of the embodiments of the present disclosure.

According to a fourth aspect, the embodiments of the present disclosure further provide a storage medium including computer executable instructions that, when executed by a computer processor, are configured to perform the method of video bitrate adjustment according to any of the embodiments of the present disclosure.

According to a fifth aspect, the embodiments of the present disclosure further provide a computer program product, including a computer program, where the computer program, when executed by a processor, implements the method of video bitrate adjustment according to any of the embodiments of the present disclosure.

### BRIEF DESCRIPTION OF DRAWINGS

The above and other features, advantages, and aspects of various embodiments of the present disclosure will become more apparent with reference to the following DETAILED DESCRIPTION in conjunction with the accompanying drawings. Throughout the drawings, the same or similar reference numerals represent the same or similar elements. It should be understood that the drawings are schematic, and components and elements are not necessarily drawn to scale.

FIG. 1 is a schematic flowchart of a method of video bitrate adjustment according to the embodiments of the present disclosure;

FIG. 2 is a schematic architectural diagram of a PSNR based target bitrate adjustment algorithm according to the embodiments of the present disclosure;

FIG. 3 is a schematic flowchart of a method of video bitrate adjustment according to the embodiments of the present disclosure;

FIG. 4 is a logic flowchart of a PSNR based bitrate control algorithm according to the embodiments of the present disclosure;

FIG. 5 is a schematic flowchart of a method of video bitrate adjustment according to the embodiments of the present disclosure;

FIG. 6 is a diagram of a change relationship between a bitrate adjustment scale factor and an average bandwidth estimation/bitrate upper limit according to the embodiments of the present disclosure;

FIG. 7 is a schematic diagram of an effective range of a bitrate upper bound promotion decision logic according to the embodiments of the present disclosure;

FIG. 8 is a schematic flowchart of a method of video bitrate adjustment according to the embodiments of the present disclosure;

FIG. 9 is a schematic diagram of a bandwidth fluctuation detection admission judgment logic compatible with multiple transmission protocols according to the embodiments of the present disclosure;

FIG. 10 is a schematic structural diagram of an apparatus for video bitrate adjustment according to the embodiments of the present disclosure; and

FIG. 11 is a schematic structural diagram of an electronic device according to the embodiments of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for example purposes only and are not intended to limit the scope of the present disclosure.

It should be understood that the steps described in the method embodiments of the present disclosure may be performed in a different order and/or in parallel. Furthermore, the method embodiments may include additional steps and/or omit performing the illustrated steps. The scope of the present disclosure is not limited in this respect.

As used herein, the term “include” and its variants should be construed as open terms meaning “including, but not limited to”. The term “based on” means “at least partially based on”. The term “one embodiment” means “at least one embodiment”. The term “another embodiment” means “at least one another embodiment”. The terms “some embodiments” means “at least some embodiments”. Related definitions of other terms will be given in the following descriptions.

It should be noted that the concepts of “first”, “second” and the like mentioned in the present disclosure are used only to distinguish different apparatuses, modules or units but not to limit the order or interdependence of the functions performed by these apparatuses, modules or units.

It should be noted that the modifications of “a” and “a plurality” mentioned in the present disclosure are schematic rather than limiting, and it should be understood by those skilled in the art that unless otherwise explicitly stated in the context, they should be understood as “one or more”.

It is to be understood that, before applying the technical solutions disclosed in various embodiments of the present disclosure, the user should be informed of the type, scope of use, and use scenario of the personal information involved in the subject matter of the present disclosure in an appropriate manner in accordance with relevant laws and regulations, and user authorization should be obtained.

For example, in response to receiving an active request from the user, prompt information is sent to the user to explicitly inform the user that the requested operation would obtain and use the user's personal information. Therefore, according to the prompt information, the user may decide on his/her own whether to provide the personal information to the software or hardware, such as electronic devices, applications, servers, or storage medium that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

It is to be understood that data involved in the present technical solution (including but not limited to the data itself, the acquisition or use of the data) should comply with requirements of corresponding laws and regulations and relevant rules.

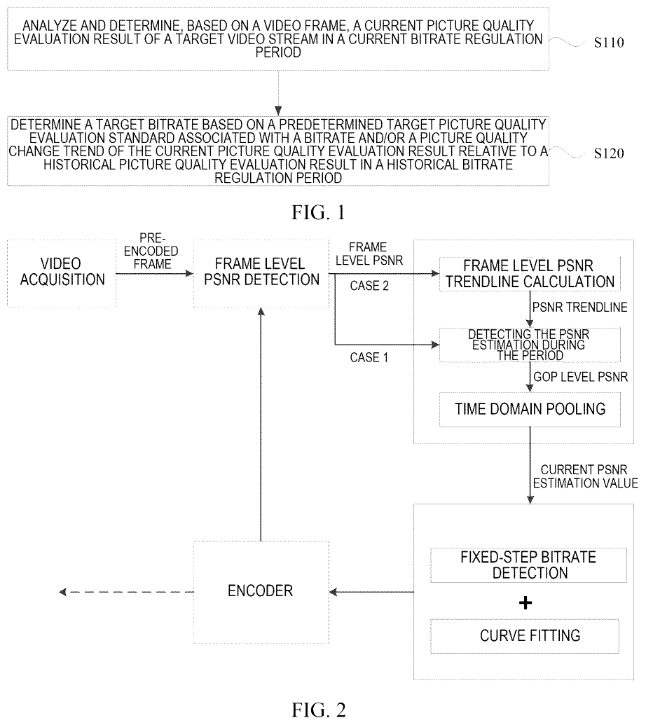

FIG. 1 is a schematic flowchart of a method of video bitrate adjustment according to the embodiments of the present disclosure. The embodiments of the present disclosure are applicable to the scenarios of video push-stream, particularly to situations of adjusting video stream processing parameters during video push-stream. The method may be performed by an apparatus for video bitrate adjustment, which may be implemented in the form of software and/or hardware. Optionally, the apparatus for video bitrate adjustment may be implemented by an electronic device, which may be a mobile terminal, a PC, or a server.

As shown in FIG. 1, the method of video bitrate adjustment includes:

At S110: analyze and determine, based on a video frame, a current picture quality evaluation result of a target video stream in a current bitrate regulation period.

The target video stream may be video stream data processed by video data encoding at the video push-stream end, such as push-stream data of the live push-stream end and video stream data in real-time communications (RTC). The video push-stream end usually performs video encoding based on a certain push-stream bitrate after the video data is collected, and performs push-stream on the encoding result to realize video data output at the video push-stream end. Generally, in the working process of the video push-stream end, the push-stream bitrate can be adaptively adjusted based on the fluctuation of the network bandwidth, so as to adapt to network fluctuation and reduce the abnormality in the working process of the video push-stream end.

In this embodiment, in addition to detecting a network bandwidth fluctuation condition, a picture quality level of the target video stream is further evaluated, a picture quality evaluation result of the target video stream is used as one of the considerations of bitrate adjustment, and a result of the bitrate adjustment is more effective for improving quality of experience (QoE) of the video application.

Specifically, if picture quality evaluation of the target video stream is performed, picture quality evaluation may be performed in stages. The bitrate regulation period of a certain duration may be set, the picture quality of the target video stream is periodically analyzed, and the bitrate adjustment is performed. Considering a feature of video encoding, when a bitrate regulation period is set, n groups of pictures (OP) may be recorded as one picture quality detection period, and k detection periods are one bitrate regulation period. In one bitrate regulation period, picture quality analysis is performed on each video frame, and then the overall evaluation is performed on all video frame picture quality analysis results in the same bitrate regulation period to obtain a picture quality evaluation result corresponding to one bitrate regulation period.

For the current bitrate regulation period, a predetermined picture quality evaluation parameter of each video frame in the current bitrate regulation period may be determined for each of pre-encoded video frames and the corresponding post-encoded video frame. The predetermined picture quality evaluation parameter may be any parameter such as a picture quality evaluation index that has a positive correlation relationship with a target bitrate value, such as Peak Signal Noise Rate (PSNR), Structural Similarity (SSIM), and Video Multi-method Assessment Fusion (VMAF). Further, time domain pooling processing may be performed on the predetermined picture quality evaluation parameter of each video frame, and the processing result is used as the current picture quality evaluation result corresponding to the current bitrate regulation period. The time domain pooling may be understood as the mean processing the picture quality evaluation data during the current bitrate regulation period.

In an optional implementation, PSNR may be used as an index and a decision basis for picture quality evaluation. The PSNR is a reference video quality objective evaluation index which is widely applied to measurement of picture and video signal reconstruction quality and compared with other picture quality evaluation indices, the video quality objective evaluation index also has the advantages of low calculation overhead and relatively small actual application power consumption. For the PSNR based target bitrate adjustment process, refer to the algorithm architecture shown in FIG. 2.

In FIG. 2, the video push-stream end first performs video collection to obtain a pre-encoded video frame. Then, frame level PSNR detection is performed in units of frames, and frame PSNR is determined based on the pre-encoded frames and the corresponding post-encoded frames. Further, the overall analysis of the frame level PSNR may be performed, which may also be classified into two cases. Case 1: if all frame PSNR in the detection period are reported, the PSNR estimation in the detection period is directly performed, and time domain pooling is performed on the frame level PSNR as the PSNR estimation value in the current bitrate regulation period. Case 2: if only part of frames of PSNR are calculated in the detection period, considering that PSNR levels of different types of frames (such as I, P, B frames, etc.) are different, the PSNR change trend in the detection period is first calculated to obtain a PSNR trendline, then the PSNR level in the detection period is estimated in combination with the change trend of the PSNR, and finally, the PSNR of all detection periods in the current bitrate regulation period is performed time domain pooling processing to obtain the PSNR estimation value of the current bitrate regulation period, that is, the current picture quality evaluation result.

At S120: determine a target bitrate based on a predetermined target picture quality evaluation standard associated with a bitrate and/or a picture quality change trend of the current picture quality evaluation result relative to a historical picture quality evaluation result in a historical bitrate regulation period.

The decision target of the target bitrate regulation is that the actual PSNR within the next bitrate regulation period is controlled within the range of target_psnr±abs_error_psnr, where target_psnr is the predetermined target picture quality evaluation standard PSNR corresponding to the current bitrate, and the control error is abs_error_psnr.

Generally, the higher the bitrate is, the clearer the video picture is, and the corresponding array of picture quality evaluation results will also be higher. In fact, there is a non-linear relationship between the bitrate and the picture quality perceived by the user, and the picture quality of the same target bitrate in different content scenarios is different. In this embodiment, an associated predetermined target picture quality evaluation standard may be predetermined for each bitrate as the expected value of the picture quality of the video frame at each bitrate. Further, the target bitrate may be adjusted based on the actual picture quality evaluation result and the expected value of the picture quality. If the actual picture quality does not reach the corresponding expectation value of the picture quality, the bitrate may be further improved under the condition that the network bandwidth is allowed, so as to improve the picture quality; if the actual picture quality has exceeded the corresponding expectation value of the picture quality, the bitrate may be further reduced, so that the bandwidth cost is saved on the premise of ensuring the picture quality. The bitrate regulation process is a cost optimized target bitrate reduction decision process based on strong picture quality.

Further, it may be determined whether a difference between the current picture quality evaluation result and a predetermined target picture quality evaluation standard corresponding to a current bitrate is within a range of a predetermined picture quality control error, and it is determined whether a plan value meets the expectation value of the picture quality. If the difference between the current picture quality evaluation result and the predetermined target picture quality evaluation standard corresponding to the current bitrate is greater than the predetermined picture quality control error, it indicates that the actual picture quality is better than the expected picture quality, and a predetermined bitrate adjustment step may be reduced based on the current bitrate to determine a target bitrate. That is, the bitrate detection of a fixed step in one period is completed. The i-th bitrate regulation period is the current bitrate regulation period, the PSNR estimation value in the i-th bitrate regulation period is current_psnr(i). If the actual PSNR level in the current bitrate regulation period is above the expected picture quality range, that is, current_psnr(i)−target_psnr>abs_error_psnr(e.g. 1 dB), and the target bitrate can be obtained by adjusting the bitrate step psnr_based_dec_step downward based on the current bitrate in the current bitrate regulation period.

In addition, in this embodiment, when the bitrate adjustment is performed, the target bitrate adjustment based on the picture quality evaluation result may be paused by considering the picture quality change trend displayed by the picture quality evaluation result. The picture quality fluctuation may be analyzed by the standard deviation sigma_psnr(i) on the current picture quality evaluation result and the historical picture quality evaluation result value. If the sigma_psnr(i) is greater than a predetermined upper limit value, that is, it indicates that the picture quality fluctuation at the current bitrate is large, it is not suitable to perform the target bitrate adjustment based on the picture quality evaluation result.

In the algorithm framework shown in FIG. 2, the target bitrate may also be adjusted in combination with a rate-distortion (RD) curve. The rate-distortion (RD) curve reflects the coding performance of different coders. The general RD curve is a curve by taking the bitrate (Kbps) as the horizontal axis and PSNR (dB) as the vertical axis, the higher the curve point indicates better performance. In an optional implementation, a result of the RD curve prediction and a result based on step length detection may be fused, and a fusion result is used as the target bitrate.

It may be understood that, in this embodiment, a process of performing bitrate adjustment is performed when a network bandwidth condition is met.

According to the technical scheme of the embodiments of the present disclosure, a current picture quality evaluation result of a target video stream in a current bitrate regulation period is analyzed and determined based on a video frame; and a target bitrate is determined based on a predetermined target picture quality evaluation standard associated with a bitrate and/or a picture quality change trend of the current picture quality evaluation result relative to a historical picture quality evaluation result in a historical bitrate regulation period. The technical solution of the embodiments of the present disclosure solves the problem that the picture quality of the video stream is not considered in the bitrate adjustment in the prior art, and the quality of experience is not improved well after the bitrate adjustment. The picture quality of the video stream can be analyzed during the video push-stream process, and the target bitrate on the video push-stream side can be adjusted based on the result of the picture quality evaluation, so that the video push-stream quality of experience is optimized under the condition of bandwidth allowance, and the bitrate adjustment is carried out from multiple dimensions (the bandwidth cost and the video stream picture quality).

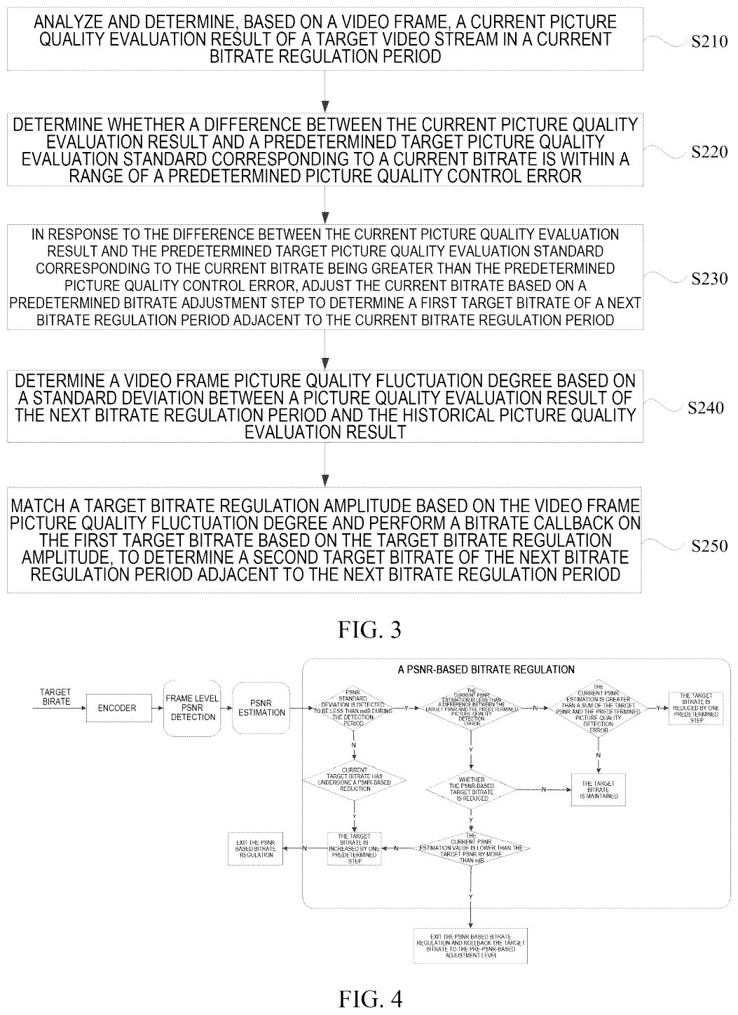

FIG. 3 is a schematic flowchart of a further method of video bitrate adjustment according to the embodiments of the present disclosure. On the basis of the above embodiments, further explanation is given on the process of adjusting the subsequent video bitrate after the bitrate has been lowered. The method may be performed by an apparatus for video bitrate adjustment, and the apparatus may be implemented in a form of software and/or hardware, optionally, implemented by using an electronic device, and the electronic device may be a mobile terminal, a PC terminal, a server, or the like.

As shown in FIG. 3, the method of video bitrate adjustment includes the following steps.

At S210: analyze and determine, based on a video frame, a current picture quality evaluation result of a target video stream in a current bitrate regulation period.

For the current bitrate regulation period, the predetermined picture quality evaluation parameter of each video frame in the current bitrate regulation period may be determined for each of pre-encoded video frames and the corresponding post-encoded video frame. The time domain pooling processing may be performed on the predetermined picture quality evaluation parameter of each video frame, and the processing result is used as the current picture quality evaluation result corresponding to the current bitrate regulation period.

At S220: determine whether a difference between the current picture quality evaluation result and a predetermined target picture quality evaluation standard corresponding to a current bitrate is within a range of a predetermined picture quality control error.

The predetermined target picture quality evaluation standard corresponding to the current bitrate is the expected value of the video frame picture quality at the current bitrate. If the difference between the current picture quality evaluation result and the corresponding predetermined target picture quality evaluation standard is within the range of the predetermined picture quality control error, it indicates that the bitrate adjustment does not need to be performed at present. If the difference between the current picture quality evaluation result and the corresponding predetermined target picture quality evaluation standard exceeds the range of the predetermined picture quality control error, it indicates that the current picture quality evaluation result has exceeded the expected picture quality to a certain extent, or the current picture quality evaluation result has been lower than the expected picture quality to a certain extent, and needs to further adjust the target bitrate.

S230: in response to the difference between the current picture quality evaluation result and the predetermined target picture quality evaluation standard corresponding to the current bitrate being greater than the predetermined picture quality control error, adjust the current bitrate based on a predetermined bitrate adjustment step to determine a first target bitrate of a next bitrate regulation period adjacent to the current bitrate regulation period.

It is considered in this step that the current picture quality evaluation result has exceeded the expected picture quality to a certain extent, and the bitrate can be reduced to reduce the bitrate and save the bandwidth cost on the premise of ensuring picture quality. The bitrate regulation process is a cost-optimized target bitrate reduction decision process based on strong picture quality. The first target bitrate of the next bitrate regulation period adjacent to the current bitrate regulation period may be determined by lowing a predetermined bitrate adjustment step based on the current bitrate.

At S240: determine a video frame picture quality fluctuation degree based on a standard deviation between a picture quality evaluation result of the next bitrate regulation period and the historical picture quality evaluation result.

As the video push-stream process continues, the apparatus for video bitrate adjustment continues to perform picture quality evaluation of the video stream based on a predetermined bitrate regulation period, and determines a fluctuation condition of the video frame picture quality in a continuous bitrate regulation period. Further, the bitrate is adjusted based on a fluctuation degree of video frame picture quality.

In this embodiment, the current bitrate regulation period and the corresponding next bitrate regulation period are merely used as an example, and the fluctuation degree of the video frame picture quality is continuously performed in a continuous bitrate regulation period.

At S250: match a target bitrate regulation amplitude based on the video frame picture quality fluctuation degree and perform a bitrate callback on the first target bitrate based on the target bitrate regulation amplitude, to determine a second target bitrate of the next bitrate regulation period adjacent to the next bitrate regulation period.

The video frame picture quality fluctuation degree reflects instability of the bitrate parameter in the current video stream processing on the current video stream. In other words, if the first target bitrate after the bitrate reduction may not adapt to the picture scene of the current video stream, the bitrate value needs to be called back, that is, a bitrate callback needs to be performed. The video frame picture quality fluctuation degree is proportional to the target bitrate regulation amplitude, for example, slight fluctuation, and may call back a step length on the basis of the first target bitrate; violent fluctuation may call back three step lengths on the basis of the first target bitrate, thereby obtaining the second target bitrate. The division criterion of the video frame picture quality fluctuation degree and the bitrate regulation step length may be set based on the actual bitrate adjustment.

Based on the foregoing embodiment content, the PSNR based bitrate control algorithm logic may refer to the schematic diagram shown in FIG. 4. A specific method for the PSNR based bitrate control module is as follows.

The goal of the algorithm's predetermined target bitrate decision is to control the PSNR in the next regulation period, i.e., current_psnr(i+1), within the range of target_psnr+abs_error_psnr based on the PSNR (denoted as current_psnr(i)) in the current bitrate regulation period. The target PSNR corresponding to the current bitrate is target_psnr, the control error is abs_error_psnr, and the i-th bitrate regulation period is the current bitrate regulation period. If the PSNR level in the current bitrate regulation period is above the control range, that is, current_psnr(i)−target_psnr>abs_error_psnr(e.g. 1 dB), one step length psnr_based_dec_step is reduced.

If the PSNR based bitrate has been reduced and the PSNR level of all detection periods in the current bitrate regulation period is relatively smooth (decision criterion: the PSNR standard deviation of all detection periods within the bitrate regulation period sigma_psnr(i)<m dB) and the current picture quality is within the target PSNR control range, that is, |current_psnr(i)−target_psnr|<abs_error_psnr, the current target bitrate is maintained (no callback nor reduction of the step length). m is a predetermined standard deviation reference threshold.

If the PSNR based bitrate has been reduced and the PSNR levels of all detection periods in the current bitrate regulation period is relatively fluctuating (decision criterion: the PSNR standard deviation sigma_psnr(i)>=m dB of all detection periods in the bitrate regulation period, that is, the picture quality fluctuation at the new bitrate is larger), the target bitrate calls back by one step length.

If the PSNR based bitrate has been reduced previously, and the PSNR level in the current bitrate regulation period is far below the control range (decision criterion: current_psnr(i)−target_psnr+abs_error_psnr>=n dB), the target bitrate quickly calls back all step lengths to the level before the PSNR based bitrate reduction. n is a predetermined value.

If there is no reduction and the PSNR levels of all detection periods in the current bitrate regulation period are relatively fluctuating (decision criterion: the PSNR standard deviation sigma_psnr(i)>=m dB of all detection periods in the bitrate regulation period, that is, the picture quality fluctuates greatly), the target bitrate decision based on PSNR is not performed.

The technical scheme of the embodiments of the present disclosure includes: analyzing and determining, based on a video frame, a current picture quality evaluation result of a target video stream in a current bitrate regulation period; determining whether a difference between the current picture quality evaluation result and a predetermined target picture quality evaluation standard corresponding to a current bitrate is within a range of a predetermined picture quality control error; in response to the difference between the current picture quality evaluation result and the predetermined target picture quality evaluation standard corresponding to the current bitrate being greater than the predetermined picture quality control error, reducing a predetermined bitrate adjustment step length on the basis of the current bitrate; determining a first target bitrate of the next bitrate regulation period adjacent to the current bitrate regulation period; based on the standard deviation between the picture quality evaluation result of the next bitrate regulation period and the corresponding historical picture quality evaluation result, determining the video frame picture quality fluctuation degree; matching a target bitrate regulation amplitude based on the video frame picture quality fluctuation degree and performing a bitrate callback on the first target bitrate based on the target bitrate regulation amplitude, to determine a second target bitrate of the next bitrate regulation period adjacent to the next bitrate regulation period, so that the picture quality stability of the video frame picture is ensured as much as possible. The technical solution of the embodiments of the present disclosure solves the problem that the picture quality of the video stream is not considered in the bitrate adjustment in the prior art, and the quality of experience is not improved well after the bitrate adjustment. The picture quality of the video stream can be analyzed during the video push-stream process, and the target bitrate on the video push-stream side can be adjusted based on the result of the picture quality evaluation, so that the video push-stream quality of experience is optimized under the condition of bandwidth allowance, and the bitrate adjustment is carried out from multiple dimensions (the bandwidth cost and the video stream picture quality).

FIG. 5 is a schematic flowchart of a method of video bitrate adjustment according to the embodiments of the present disclosure. On the basis of the above-mentioned embodiments, in the process of implementing the method flow of video bitrate adjustment, the decision of improving the bitrate upper bound based on strong network and low picture quality for experience optimization is further explained. The method may be performed by an apparatus for video bitrate adjustment, and the apparatus may be implemented in a form of software and/or hardware, optionally, implemented by using an electronic device, and the electronic device may be a mobile terminal, a PC terminal, a server, or the like.

As shown in FIG. 5, the method of video bitrate adjustment includes the following steps.

At S310: analyze and determine, based on a video frame, a current picture quality evaluation result of a target video stream in a current bitrate regulation period.

At S320, in accordance with a determination that the current bitrate is a bitrate upper limit value in a predetermined bit-table and a network state satisfies a predetermined high-quality network evaluation standard, compare the current picture quality evaluation result with a predetermined target picture quality evaluation standard corresponding to the current bitrate.

In the video push-stream start phase, the target bitrate is usually determined based on a bitrate value in a predetermined bit-table, and is subject to a bitrate upper limit value in the predetermined bit-table. If the network state is relatively good, the bitrate upper limit value configured by the bit-table in the default current resolution is the target bitrate for encoding. Part of such a design is to prevent deterioration of the jamming performance caused by excessively high bitrate, but also becomes a bottleneck of improving the video picture quality in a case where some network states are good.

The predetermined picture quality reference interval may be a numerical range of a picture quality evaluation index when the target video stream enables the user to have a better quality experience. The settings may be set based on quality of experience standards. If the current bitrate is a bitrate that is a bitrate upper limit value in the predetermined bit-table, the current picture quality evaluation result is compared with the predetermined reference interval quality reference interval, that is, whether the improvement of the video picture quality is limited is determined.

At S330, in accordance with a determination that the current picture quality evaluation result is lower than a predetermined target picture quality evaluation standard corresponding to the current bitrate, adjust the bitrate upper limit value.

If the current picture quality evaluation result is lower than a lower limit of the predetermined target picture quality reference interval, it indicates that the video picture quality improvement of the target video stream has encountered a bottleneck when the network state is better, and the bitrate upper limit value needs to be adjusted to remove the limitation of picture quality improvement.

In an optional implementation, the adjusting the bitrate upper limit value may first determine a bitrate adjustment scale factor based on a ratio of a current average bandwidth estimation value to the bitrate upper limit value; and then, determine and adjust to obtain a new bitrate upper limit value based on the bitrate adjustment scale factor and the bitrate upper limit value. That is, the multiplication of the bitrate upper limit value and the bitrate adjustment scale factor is used as the new bitrate upper limit value.

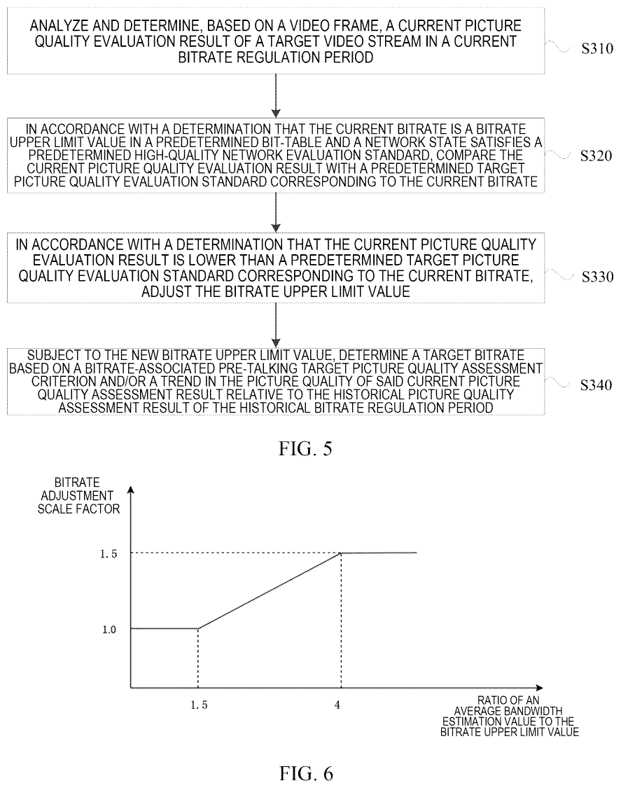

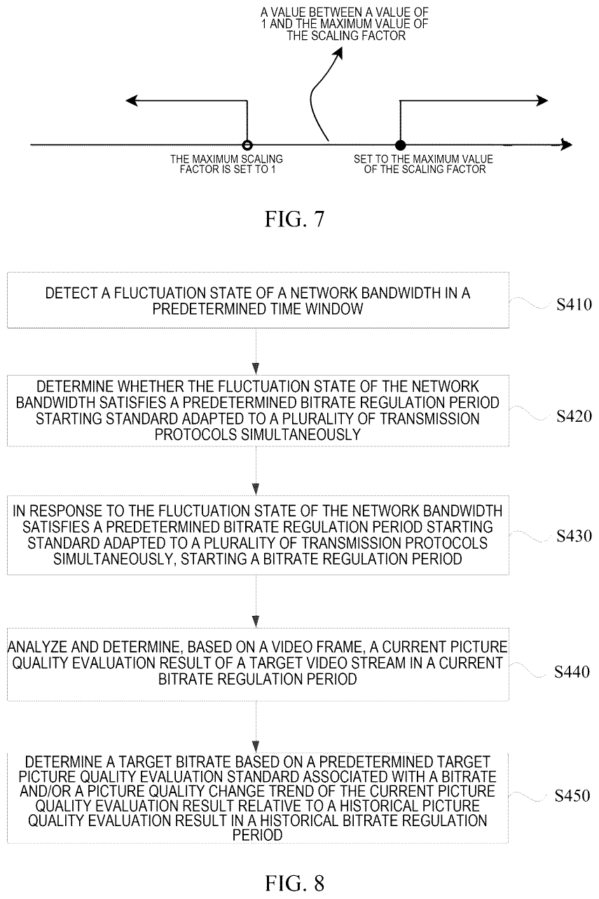

The bitrate adjustment scale factor is determined based on a ratio of the average bandwidth estimation to the bitrate upper limit value, because the bitrate cannot be increased indefinitely, and it is necessary to consider whether the bandwidth can support the increase of the bitrate. Therefore, the bitrate is adjusted under the constraint of the bandwidth. For the value of the bitrate adjustment scale factor, refer to the change relationship diagram between the bitrate adjustment scale factor and the average bandwidth estimation/bitrate upper limit shown in FIG. 6. The specific effective logic thereof may refer to the schematic diagram of the effective range of the upper bound promotion decision logic of the bitrate shown in FIG. 7. If the ratio of the average bandwidth estimation to the bitrate upper limit value is less than 1.5, the bitrate adjustment scale factor is both 1, that is, the bitrate upper limit value is not increased. If the ratio of the average bandwidth estimation to the bitrate upper limit value is greater than 4, the bitrate adjustment scale factor is the upper limit value 1.5 of the bitrate adjustment scale factor, that is, the bitrate upper limit value is not increased. If the ratio of the average bandwidth estimation to the bitrate upper limit value is between 1.5 and 4, the bitrate adjustment scale factor is determined based on the linear relationship between the average bandwidth estimation and the bitrate upper limit value. It should be noted that, 1.5 and 4 are merely example values, which indicate that the value of the bitrate adjustment scale factor is limited by a certain threshold or a maximum scale factor.

At S340, subject to the new bitrate upper limit value, determine a target bitrate based on a bitrate-associated pre-talking target picture quality assessment criterion and/or a trend in the picture quality of said current picture quality assessment result relative to the historical picture quality assessment result of the historical bitrate regulation period.

Under the constraint of the new bitrate upper limit value, based on the method of video bitrate adjustment provided in the foregoing embodiment, the picture quality of the video stream can be further improved, and the quality of experience is improved under the requirement of meeting the predetermined bandwidth cost.

The technical scheme of the embodiments of the present disclosure comprises: analyzing and determining, based on a video frame, a current picture quality evaluation result of a target video stream in a current bitrate regulation period; in accordance with a determination that the current bitrate is a bitrate upper limit value in a predetermined bit-table and a network state satisfies a predetermined high-quality network evaluation standard, comparing the current picture quality evaluation result with a predetermined target picture quality evaluation standard corresponding to the current bitrate; in accordance with a determination that the current picture quality evaluation result is lower than a predetermined target picture quality evaluation standard corresponding to the current bitrate, adjusting the bitrate upper limit value; subject to the new bitrate upper limit value, determining a target bitrate based on a bitrate-associated pre-talking target picture quality assessment criterion and/or a trend in the picture quality of said current picture quality assessment result relative to the historical picture quality assessment result of the historical bitrate regulation period. The technical scheme of the embodiment solves the problem of bottleneck of video stream picture quality improvement under the limitation of a bit-table. It can evaluate the network bandwidth and the video frame picture in the video stream transmission process and appropriately adjust the bitrate upper limit value to optimize the video frame quality.

FIG. 8 is a schematic flowchart of a method of video bitrate adjustment according to the embodiments of the present disclosure. On the basis of the above-mentioned embodiments, in the process of implementing the method flow of video bitrate adjustment, the process of entering and exiting the bitrate regulation period in order to achieve the compatibility of multiple communication protocols of the method of video bitrate adjustment is further explained. The method may be performed by an apparatus for video bitrate adjustment, and the apparatus may be implemented in a form of software and/or hardware, optionally, implemented by using an electronic device, and the electronic device may be a mobile terminal, a PC terminal, a server, or the like.

As shown in FIG. 8, the method of video bitrate adjustment includes the following steps.

At S410: detect a fluctuation state of a network bandwidth in a predetermined time window.

The predetermined time window may be a time period after the video stream transmission process is started, and the length of the time window may be set. This time point is taken as the investigation time of the enabling condition of the method of video bitrate adjusting in this embodiment. The value of the network bandwidth can determine whether the video stream transmission is satisfied, and the fluctuation state of the network bandwidth can reflect the stability of the network.

At S420: determine whether the fluctuation state of the network bandwidth satisfies a predetermined bitrate regulation period starting standard adapted to a plurality of transmission protocols simultaneously.

The predetermined bitrate regulation period starting standard is determined based on a relationship between a bandwidth fluctuation trend and a bandwidth estimation value in a time window and a bitrate upper limit. Only if the network state is stable and the network bandwidth is sufficient (strong network) can meet the predetermined bitrate regulation period starting standard. In other words, the “strict entry and loose exit” admittance condition is adopted, “strict entry” ensures that it is enabled only after sufficient bandwidth is detected at the transmission layer, and “loose exit” ensures that the algorithm for performing bitrate regulation based on picture quality will not be repeatedly turned on and off at high frequency.

At S430: in response to the fluctuation state of the network bandwidth satisfies a predetermined bitrate regulation period starting standard adapted to a plurality of transmission protocols simultaneously, starting a bitrate regulation period.

The admittance condition of the bitrate adjustment is “determine that the current network is a strong network”. The criterion for determining a strong network may be that the bandwidth estimation is stable (no significant decrease in the N bandwidth estimations occurs within the detection window time range) and is continuously higher than the original bit-table upper bound. If the criteria for determining a strong network are met, the bitrate upper bound improvement decision based on the strong network low picture quality is admitted, and whether the upper bound increase is performed is determined based on the level of the PSNR.

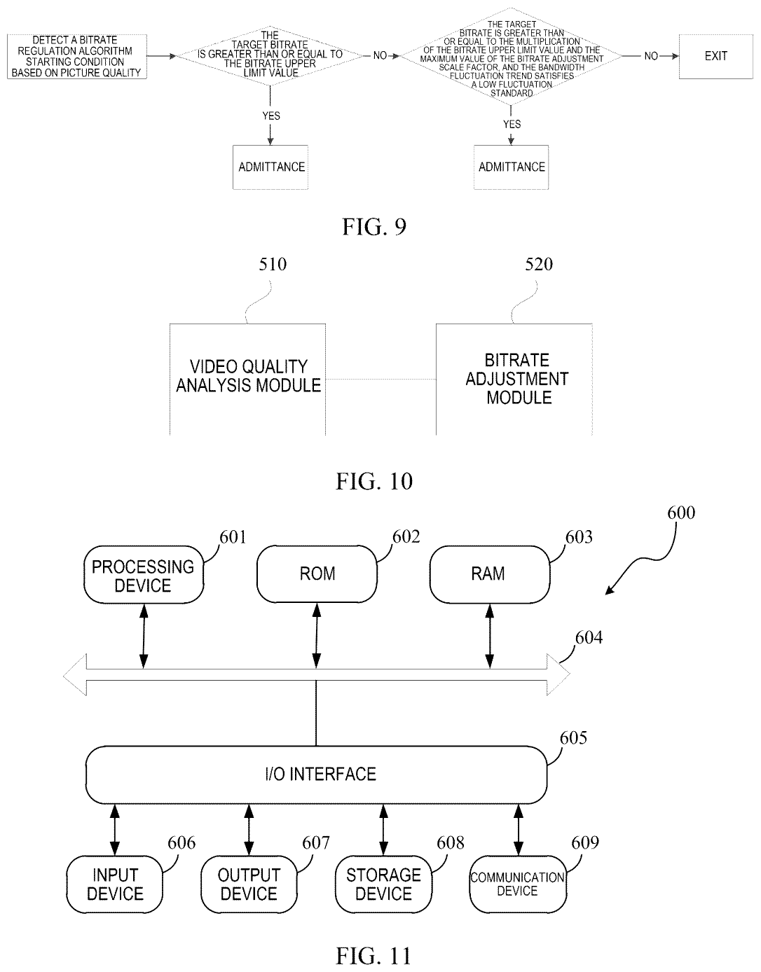

In addition, in a process of performing bitrate adjustment, a percentage of max bitrates may be set. That is, if it is detected that the target bitrate is greater than or equal to the bitrate upper limit value, or if the target bitrate is greater than or equal to the multiplication of the bitrate upper limit value and the bitrate adjustment scale factor maximum value, and the bandwidth fluctuation trend meets the low fluctuation standard, it may be admitted (that is, the bitrate regulation period is started), otherwise, the bitrate adjustment period is exited (that is, the bitrate rate regulation period ends). See also FIG. 9 for bandwidth fluctuation detection admittance determination logic compatible with multiple transmission protocols.

At S440: analyze and determine, based on a video frame, a current picture quality evaluation result of a target video stream in a current bitrate regulation period.

At S450: determine a target bitrate based on a predetermined target picture quality evaluation standard associated with a bitrate and/or a picture quality change trend of the current picture quality evaluation result relative to a historical picture quality evaluation result in a historical bitrate regulation period.

According to the technical scheme of the embodiments of the present disclosure, the fluctuation state of the network bandwidth in the predetermined time window is detected. Whether the fluctuation state of the network bandwidth satisfies a predetermined bitrate regulation period starting standard adapted to a plurality of transmission protocols simultaneously is determined. If the fluctuation state of the network bandwidth satisfies the predetermined bitrate regulation period starting standard adapted to the plurality of transmission protocols simultaneously, the bitrate regulation period is started. A current picture quality evaluation result of a target video stream in a current bitrate regulation period is determined and analyzed based on a video frame. A target bitrate is determined based on a predetermined target picture quality evaluation standard associated with a bitrate and/or a picture quality change trend of the current picture quality evaluation result relative to a historical picture quality evaluation result in a historical bitrate regulation period. That is, through the design of the startup rule of the bitrate regulation period, the technical solution of this embodiment can be compatible with multiple transmission protocols such as RTMP based on TCP, QUIC based on UDP, and WebRTC. The video stream application can run under multiple protocols, and better quality of experience can be achieved.

FIG. 10 is an apparatus for video bitrate adjustment according to the embodiments of the present disclosure. The apparatus is applicable to a video push-stream scenario, in particular, a case of adjusting a video stream processing parameter in a video push-stream process. The apparatus for video bitrate adjustment may be implemented in a form of software and/or hardware, and may be configured on an electronic device, and the electronic device may be a mobile terminal, a PC terminal, a server, or the like.

As shown in FIG. 10, the apparatus for video bitrate adjustment includes a video quality analysis module 510 and a bitrate adjustment module 520.

The video quality analysis module 510 is configured to analyze and determine, based on a video frame, a first picture quality evaluation result of a target video stream in a current bitrate regulation period; and a bitrate adjustment module 520 is configured to determine a target bitrate based on a predetermined target picture quality evaluation standard associated with a bitrate and/or a picture quality change trend of the first picture quality evaluation result relative to a second picture quality evaluation result in a historical bitrate regulation period.

According to the technical scheme of the embodiments of the present disclosure, a current picture quality evaluation result of a target video stream in a current bitrate regulation period is analyzed and determined based on a video frame; and a target bitrate is determined based on a predetermined target picture quality evaluation standard associated with a bitrate and/or a picture quality change trend of the current picture quality evaluation result relative to a historical picture quality evaluation result in a historical bitrate regulation period. The technical solution of the embodiments of the present disclosure solves the problem that the picture quality of the video stream is not considered in the bitrate adjustment in the prior art, and the quality of experience is not improved well after the bitrate adjustment. The picture quality of the video stream can be analyzed during the video push-stream process, and the target bitrate on the video push-stream side can be adjusted based on the result of the picture quality evaluation, thereby optimizing the video push-stream quality of experience when bandwidth permits.

In an optional implementation, the video quality analysis module 510 is specifically configured to: determine, based on each pre-encoded video frame and a corresponding post-encoded video frame of the target video stream, a predetermined picture quality evaluation parameter of each video frame in the current bitrate regulation period; and perform time domain pooling processing on the predetermined picture quality evaluation parameter of each video frame, to obtain the current picture quality evaluation result.

In an optional implementation, the bitrate adjustment module 520 is specifically configured to:
determine whether a difference between the current picture quality evaluation result and a predetermined target picture quality evaluation standard corresponding to a current bitrate is within a range of a predetermined picture quality control error; and
in response to the difference between the current picture quality evaluation result and the predetermined target picture quality evaluation standard corresponding to the current bitrate being greater than the predetermined picture quality control error, adjust the current bitrate based on a predetermined bitrate adjustment step to determine the target bitrate.

In an optional implementation, the bitrate adjustment module 520 may be further configured to:
determine a video frame picture quality fluctuation degree based on a standard deviation between the current picture quality evaluation result and the historical picture quality evaluation result; and
determine, according to the video frame picture quality fluctuation degree, a target bitrate of a next bitrate regulation period adjacent to the current bitrate regulation period based on the current bitrate.

In an optional implementation, the bitrate adjustment module 520 may be further configured to:
in response to the current bitrate being a bitrate value that has undergone a bitrate reduction, match a target bitrate regulation amplitude based on the video frame picture quality fluctuation degree; and
perform a bitrate callback on the current bitrate based on the target bitrate regulation amplitude, to determine a target bitrate of the next bitrate regulation period adjacent to the current bitrate regulation period.

In an optional implementation, the apparatus for video bitrate adjustment further includes a bitrate limit value adjustment module, configured to:
in accordance with a determination that the current bitrate is a bitrate upper limit value in a predetermined bit-table and a network state satisfies a predetermined high-quality network evaluation standard, compare the current picture quality evaluation result with a predetermined target picture quality reference interval; and
in accordance with a determination that the current picture quality evaluation result is lower than a lower limit of the predetermined target picture quality reference interval, adjust the bitrate upper limit value.

In an optional implementation, the bitrate limit value adjustment module is further configured to:
determine a bitrate adjustment scale factor based on a ratio of a current average bandwidth estimation value to the bitrate upper limit value; and
determine and adjust to obtain a new bitrate upper limit value based on the bitrate adjustment scale factor and the bitrate upper limit value.

In an optional implementation, the apparatus for video bitrate adjustment further includes a bitrate regulation switch module, configured to:
detect a fluctuation state of a network bandwidth in a predetermined time window before starting a bitrate regulation period; and
determine whether the fluctuation state of the network bandwidth satisfies a predetermined bitrate regulation period starting standard adapted to a plurality of transmission protocols simultaneously.

The apparatus for video bitrate adjustment provided by the embodiments of the present disclosure may perform the method of video bitrate adjustment provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

According to the embodiments of the present disclosure, a current picture quality evaluation result of a target video stream in a current bitrate regulation period is analyzed and determined based on a video frame; and a target bitrate is determined based on a predetermined target picture quality evaluation standard associated with a bitrate and/or a picture quality change trend of the current picture quality evaluation result relative to a historical picture quality evaluation result in a historical bitrate regulation period. The technical solution of the embodiments of the present disclosure solves the problem that the picture quality of the video stream is not considered in the bitrate adjustment in the prior art, and the quality of experience is not improved well after the bitrate adjustment. The picture quality of the video stream can be analyzed during the video push-stream process, and the target bitrate on the video push-stream side can be adjusted based on the result of the picture quality evaluation, thereby optimizing the video push-stream quality of experience when bandwidth permits.

FIG. 11 is a schematic structural diagram of an electronic device provided by the embodiments of the present disclosure. The following refers to FIG. 11, which is a schematic structural diagram of an electronic device 600 (such as the terminal device or server in FIG. 11) suitable for implementing the embodiments of the present disclosure. The terminal device in the embodiments of the present disclosure may include a mobile terminal such as a mobile phone, a notebook computer, a digital broadcast receiver, a personal digital assistant (PDA), a portable android device (PAD), a portable media player (PMP), an in-vehicle terminal (for example, an in-vehicle navigation terminal), and a fixed terminal such as a digital television (TV), a desktop computer, or the like. The electronic device shown in FIG. 11 is merely an example.

As shown in FIG. 11, the electronic device 600 may include a processing device 601 (for example, a central processor, a graphics processor, etc.), which may perform various appropriate actions and processing according to a program stored in a read only memory (ROM) 602 or a program loaded into a random access memory (RAM) 603 from a storage device 608. In the RAM 603, various programs and data required by the operation of the electronic device 600 are also stored. The processing device 601, the ROM 602, and the RAM 603 are connected to each other through a bus 604. An input/output (I/O) interface 605 is also connected to the bus 604.

Generally, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to communicate wirelessly or wired with other devices to exchange data. While FIG. 11 shows an electronic device 600 having various devices, it should be understood that it is not required to implement or have all illustrated devices. More or fewer devices may alternatively be implemented or provided.

In particular, according to the embodiments of the present disclosure, the process described above with reference to the flowchart may be implemented as a computer software program according to the embodiments of the present disclosure. For example, the embodiments of the present disclosure include a computer program product comprising a computer program embodied on a non-transitory computer readable medium, the computer program comprising program code for performing the method shown in the flowchart. In such embodiment, the computer program may be downloaded and installed from the network through the communication device 609, or installed from the storage device 608, or from the ROM 602. When the computer program is executed by the processing device 601, the foregoing functions defined in the method of the embodiments of the present disclosure are performed.

The names of messages or information exchanged between multiple apparatuses in the embodiments of the present disclosure are for illustrative purposes only and are not intended to limit the scope of such messages or information.

The electronic device provided by the embodiments of the present disclosure and the method of video bitrate adjustment provided in the foregoing embodiments belong to the same inventive concept, technical details not described in detail in this embodiment may refer to the foregoing embodiments, and this embodiment has the same beneficial effects as the foregoing embodiments.

The embodiments of the present disclosure further provide a computer storage medium having a computer program stored thereon. The program, when executed by a processor, implements the method of video bitrate adjustment provided in the foregoing embodiments.

It should be noted that in the context of the present disclosure, a computer readable medium may be a tangible medium that may contain or store a program for use by or in conjunction with an instruction execution system, apparatus, or device. The computer readable medium may be a computer readable signal medium or a computer readable storage medium or any combination of the two. The computer readable storage medium may be, for example, but is not limited to: an electrical, magnetic, optical, electromagnetic, infrared, or semiconductor system, apparatus, or device, or any combination thereof. More specific examples of computer readable storage medium may include, but are not limited to: an electrical connection having one or more wires, a portable computer disk, a hard drive, a random access memory (RAM), a read only memory (ROM), an erasable programmed read-only memory (EPROM or flash memory), fiber optics, a portable compact disk read-only memory (CD-ROM), an optical storage device, an magnetic storage device, or any suitable combination of the above. In the present disclosure, a computer readable storage medium may be any tangible medium that contains or stores a program for use by or in connection with an instruction execution system, apparatus, or device. In the present disclosure, a computer readable signal medium may include a data signal propagated in a baseband or as part of a carrier wave, carrying computer readable program code therein. Such propagated data signal may take many forms, including but not limited to electromagnetic signals, optical signals, or any suitable combination of the above. A computer readable signal medium may also be any computer readable medium other than a computer readable storage medium that may send, propagate, or transmit a program for use by or in connection with an instruction execution system, apparatus, or device. Program code embodied on a computer readable medium may be transmitted using any suitable medium, including but not limited to: wire, optical cable, RF (radio frequency), etc., or any suitable combination of the above.

In some implementations, clients and servers can communicate with any currently known or future developed network protocol such as HyperText Transfer Protocol (HTTP) and can interconnect with any form or medium of digital data communication (e.g., communication networks). Examples of communication networks include local area networks (LANs), wide area networks (WANs), the Internet (such as the Internet), and end-to-end networks (e.g., ad hoc end-to-end networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to:
analyzing and determining, based on a video frame, a current picture quality evaluation result of a target video stream in a current bitrate regulation period; and
determining a target bitrate based on a predetermined target picture quality evaluation standard associated with a bitrate and/or a picture quality change trend of the current picture quality evaluation result relative to a historical picture quality evaluation result in a historical bitrate regulation period.

The computer program code for performing the operations of the present disclosure may be written in one or more programming languages or a combination thereof, which include but are not limited to object-oriented programming languages Java, Smalltalk, C++, and conventional procedural programming languages such as “C” or similar programming languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and the block diagrams in the drawings illustrate system architectures, functions and operations that may be implemented based on the system, method and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations, or can be implemented by the combination of dedicated hardware and computer instructions.

The modules described in the embodiments of the present disclosure may be implemented by way of software or hardware. In some cases, the names of the modules do not constitute limitations to the modules themselves. For example, the first obtaining unit may be further described as “a unit that obtains at least two internet protocol addresses”.

The functions described above may be performed, at least in part, by one or more hardware logic components. For example, without limitation, example types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof.

The embodiments of the present disclosure further provide a computer program product, including a computer program, where the computer program, when executed by a processor, implements the method of video bitrate adjustment provided by any embodiment of the present disclosure.

The computer program product, during implementation, may write computer program code for performing the operations of the present disclosure in one or more programming languages, or a combination thereof, including an object oriented programming language, such as Java, Smalltalk, C++, and also conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

According to one or more embodiments of the present disclosure, [Example 1] provides a method of video bitrate adjustment, comprising:
analyzing and determining, based on a video frame, a current picture quality evaluation result of a target video stream in a current bitrate regulation period; and
determining a target bitrate based on a predetermined target picture quality evaluation standard associated with a bitrate and/or a picture quality change trend of the current picture quality evaluation result relative to a historical picture quality evaluation result in a historical bitrate regulation period.

According to one or more embodiments of the present disclosure, [Example 2] provides a method of video bitrate adjustment, further comprising:
in some optional implementations, analyzing and determining, based on the video frame, the current picture quality evaluation result of the target video stream in the current bitrate regulation period comprises:
determining, based on each pre-encoded video frame and a corresponding post-encoded video frame of the target video stream, a predetermined picture quality evaluation parameter of each video frame in the current bitrate regulation period; and performing time domain pooling processing on the predetermined picture quality evaluation parameter of each video frame, to obtain the current picture quality evaluation result.

According to one or more embodiments of the present disclosure, [Example 3] provides a method of video bitrate adjustment, comprising:

in some optional implementations, determining the target bitrate based on the predetermined target picture quality evaluation standard associated with the bitrate comprises:
determining whether a difference between the current picture quality evaluation result and a predetermined target picture quality evaluation standard corresponding to a current bitrate is within a range of a predetermined picture quality control error; and
in response to the difference between the current picture quality evaluation result and the predetermined target picture quality evaluation standard corresponding to the current bitrate being greater than the predetermined picture quality control error, adjusting the current bitrate based on a predetermined bitrate adjustment step to determine the target bitrate.

According to one or more embodiments of the present disclosure, [Example 4] provides a method of video bitrate adjustment, further comprising:

in some optional implementations, determining the target bitrate based on the picture quality change trend of the current picture quality evaluation result relative to the historical picture quality evaluation result in the historical bitrate regulation period comprises:
determining a video frame picture quality fluctuation degree based on a standard deviation between the current picture quality evaluation result and the historical picture quality evaluation result; and
determining, according to the video frame picture quality fluctuation degree, a target bitrate of a next bitrate regulation period adjacent to the current bitrate regulation period based on the current bitrate.

According to one or more embodiments of the present disclosure, [Example 5] provides a method of video bitrate adjustment, further comprising:

in some optional implementations, in response to the current bitrate being a bitrate value that has undergone a bitrate reduction, determining, according to the video frame picture quality fluctuation degree, a target bitrate of a next bitrate regulation period adjacent to the current bitrate regulation period based on the current bitrate comprises: matching a target bitrate regulation amplitude based on the video frame picture quality fluctuation degree; and performing a bitrate callback on the current bitrate based on the target bitrate regulation amplitude, to determine a target bitrate of the next bitrate regulation period adjacent to the current bitrate regulation period.

According to one or more embodiments of the present disclosure, [Example 6] provides a method of video bitrate adjustment, further comprising:
in some optional implementations, the method further includes:
in accordance with a determination that the current bitrate is a bitrate upper limit value in a predetermined bit-table and a network state satisfies a predetermined high-quality network evaluation standard, comparing the current picture quality evaluation result with a predetermined target picture quality reference interval; and
in accordance with a determination that the current picture quality evaluation result is lower than a lower limit of the predetermined target picture quality reference interval, adjusting the bitrate upper limit value.

According to one or more embodiments of the present disclosure, [Example 7] provides a method of video bitrate adjustment, further comprising:
in some optional implementations, adjusting the bitrate upper limit value comprises:
determining a bitrate adjustment scale factor based on a ratio of a current average bandwidth estimation value to the bitrate upper limit value; and
determining and adjusting to obtain a new bitrate upper limit value based on the bitrate adjustment scale factor and the bitrate upper limit value.

According to one or more embodiments of the present disclosure, [Example 8] provides a method of video bitrate adjustment, further comprising:
in some optional implementations, the method further includes:
detecting a fluctuation state of a network bandwidth in a predetermined time window before starting a bitrate regulation period; and
determining whether the fluctuation state of the network bandwidth satisfies a predetermined bitrate regulation period starting standard adapted to a plurality of transmission protocols simultaneously.

According to one or more embodiments of the present disclosure, [Example 9] provides an apparatus for video bitrate adjustment, comprising:
a video quality analysis module configured to analyze and determine, based on a video frame, a first picture quality evaluation result of a target video stream in a current bitrate regulation period; and
a bitrate adjustment module configured to determine a target bitrate based on a predetermined target picture quality evaluation standard associated with a bitrate and/or a picture quality change trend of the first picture quality evaluation result relative to a second picture quality evaluation result in a historical bitrate regulation period.

According to one or more embodiments of the present disclosure, [Example 10] provides an apparatus for video bitrate adjustment, further comprising:
in an optional implementation, the video quality analysis module is specifically configured to:
determine, based on each pre-encoded video frame and a corresponding post-encoded video frame of the target video stream, a predetermined picture quality evaluation parameter of each video frame in the current bitrate regulation period; and
perform time domain pooling processing on the predetermined picture quality evaluation parameter of each video frame, to obtain the current picture quality evaluation result.

According to one or more embodiments of the present disclosure, [Example 11] provides an apparatus for video bitrate adjustment, further comprising:
in an optional implementation, the bitrate adjustment module is specifically configured to:
determine whether a difference between the current picture quality evaluation result and a predetermined target picture quality evaluation standard corresponding to a current bitrate is within a range of a predetermined picture quality control error; and
in response to the difference between the current picture quality evaluation result and the predetermined target picture quality evaluation standard corresponding to the current bitrate being greater than the predetermined picture quality control error, adjust the current bitrate based on a predetermined bitrate adjustment step to determine the target bitrate.

According to one or more embodiments of the present disclosure, [Example 12] provides an apparatus for video bitrate adjustment, further comprising:
in an optional implementation, the bitrate adjustment module may be further configured to:
determine a video frame picture quality fluctuation degree based on a standard deviation between the current picture quality evaluation result and the historical picture quality evaluation result; and
determine, according to the video frame picture quality fluctuation degree, a target bitrate of a next bitrate regulation period adjacent to the current bitrate regulation period based on the current bitrate.

According to one or more embodiments of the present disclosure, [Example 13] provides an apparatus for video bitrate adjustment, further comprising:
in an optional implementation, the bitrate adjustment module may be further configured to:
in response to the current bitrate being a bitrate value that has undergone a bitrate reduction, match a target bitrate regulation amplitude based on the video frame picture quality fluctuation degree; and
perform a bitrate callback on the current bitrate based on the target bitrate regulation amplitude, to determine a target bitrate of the next bitrate regulation period adjacent to the current bitrate regulation period.

According to one or more embodiments of the present disclosure, [Example 14] provides an apparatus for video bitrate adjustment, further comprising:
in an optional implementation, the apparatus for video bitrate adjustment further includes a bitrate limit value adjustment module, configured to:
in accordance with a determination that the current bitrate is a bitrate upper limit value in a predetermined bit-table and a network state satisfies a predetermined high-quality network evaluation standard, compare the current picture quality evaluation result with a predetermined target picture quality reference interval; and
in accordance with a determination that the current picture quality evaluation result is lower than a lower limit of the predetermined target picture quality reference interval, adjust the bitrate upper limit value.

According to one or more embodiments of the present disclosure, [Example 15] provides an apparatus for video bitrate adjustment, further comprising:
in an optional implementation, the bitrate limit value adjustment module is further configured to:
determine a bitrate adjustment scale factor based on a ratio of a current average bandwidth estimation value to the bitrate upper limit value; and
determine and adjust to obtain a new bitrate upper limit value based on the bitrate adjustment scale factor and the bitrate upper limit value.

According to one or more embodiments of the present disclosure, [Example 16] provides an apparatus for video bitrate adjustment, further comprising:
in an optional implementation, the apparatus for video bitrate adjustment further includes a bitrate regulation switch module, configured to:
detect a fluctuation state of a network bandwidth in a predetermined time window before starting a bitrate regulation period; and
determine whether the fluctuation state of the network bandwidth satisfies a predetermined bitrate regulation period starting standard adapted to a plurality of transmission protocols simultaneously.

The above description is merely an illustration of the preferred embodiments of the present disclosure and the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

I/We claim:

1. A method of video bitrate adjustment, comprising:
analyzing and determining, based on a video frame, a current picture quality evaluation result of a target video stream in a current bitrate regulation period; and
determining a target bitrate based on a predetermined target picture quality evaluation standard associated with a bitrate and/or a picture quality change trend of the current picture quality evaluation result relative to a historical picture quality evaluation result in a historical bitrate regulation period.

2. The method of claim 1, wherein analyzing and determining, based on the video frame, the current picture quality evaluation result of the target video stream in the current bitrate regulation period comprises:
determining, based on each pre-encoded video frame and a corresponding post-encoded video frame of the target video stream, a predetermined picture quality evaluation parameter of each video frame in the current bitrate regulation period; and
performing time domain pooling processing on the predetermined picture quality evaluation parameter of each video frame, to obtain the current picture quality evaluation result.

3. The method of claim 1, wherein determining the target bitrate based on the predetermined target picture quality evaluation standard associated with the bitrate comprises:
determining whether a difference between the current picture quality evaluation result and a predetermined target picture quality evaluation standard corresponding to a current bitrate is within a range of a predetermined picture quality control error; and
in response to the difference between the current picture quality evaluation result and the predetermined target picture quality evaluation standard corresponding to the current bitrate being greater than the predetermined picture quality control error, adjusting the current bitrate based on a predetermined bitrate adjustment step to determine the target bitrate.

4. The method of claim 1, wherein determining the target bitrate based on the picture quality change trend of the current picture quality evaluation result relative to the historical picture quality evaluation result in the historical bitrate regulation period comprises:
determining a video frame picture quality fluctuation degree based on a standard deviation between the current picture quality evaluation result and the historical picture quality evaluation result; and
determining, according to the video frame picture quality fluctuation degree, a target bitrate of a next bitrate regulation period adjacent to the current bitrate regulation period based on the current bitrate.

5. The method of claim 4, wherein in response to the current bitrate being a bitrate value that has undergone a bitrate reduction, determining, according to the video frame picture quality fluctuation degree, a target bitrate of a next bitrate regulation period adjacent to the current bitrate regulation period based on the current bitrate comprises:
matching a target bitrate regulation amplitude based on the video frame picture quality fluctuation degree; and
performing a bitrate callback on the current bitrate based on the target bitrate regulation amplitude, to determine a target bitrate of the next bitrate regulation period adjacent to the current bitrate regulation period.

6. The method of claim 1, further comprising:
in accordance with a determination that the current bitrate is a bitrate upper limit value in a predetermined bit-table and a network state satisfies a predetermined high-quality network evaluation standard, comparing the current picture quality evaluation result with a predetermined target picture quality reference interval; and
in accordance with a determination that the current picture quality evaluation result is lower than a lower limit of the predetermined target picture quality reference interval, adjusting the bitrate upper limit value.

7. The method of claim 6, wherein adjusting the bitrate upper limit value comprises:
determining a bitrate adjustment scale factor based on a ratio of a current average bandwidth estimation value to the bitrate upper limit value; and
determining and adjusting to obtain a new bitrate upper limit value based on the bitrate adjustment scale factor and the bitrate upper limit value.

8. The method of claim 1, further comprising:
detecting a fluctuation state of a network bandwidth in a predetermined time window before starting a bitrate regulation period; and
determining whether the fluctuation state of the network bandwidth satisfies a predetermined bitrate regulation period starting standard adapted to a plurality of transmission protocols simultaneously.

9. An electronic device, comprising:
one or more processors;
a storage device storing one or more programs,
wherein the one or more programs, when executed by the one or more processors, causes the one or more processors to implement acts of video bitrate adjustment, the acts comprising:
analyzing and determining, based on a video frame, a current picture quality evaluation result of a target video stream in a current bitrate regulation period; and
determining a target bitrate based on a predetermined target picture quality evaluation standard associated with a bitrate and/or a picture quality change trend of the current picture quality evaluation result relative to a historical picture quality evaluation result in a historical bitrate regulation period.

10. The device of claim 9, wherein analyzing and determining, based on the video frame, the current picture quality evaluation result of the target video stream in the current bitrate regulation period comprises:
determining, based on each pre-encoded video frame and a corresponding post-encoded video frame of the target video stream, a predetermined picture quality evaluation parameter of each video frame in the current bitrate regulation period; and
performing time domain pooling processing on the predetermined picture quality evaluation parameter of each video frame, to obtain the current picture quality evaluation result.

11. The device of claim 9, wherein determining the target bitrate based on the predetermined target picture quality evaluation standard associated with the bitrate comprises:
determining whether a difference between the current picture quality evaluation result and a predetermined target picture quality evaluation standard corresponding to a current bitrate is within a range of a predetermined picture quality control error; and
in response to the difference between the current picture quality evaluation result and the predetermined target picture quality evaluation standard corresponding to the current bitrate being greater than the predetermined picture quality control error, adjusting the current bitrate based on a predetermined bitrate adjustment step to determine the target bitrate.

12. The device of claim 9, wherein determining the target bitrate based on the picture quality change trend of the current picture quality evaluation result relative to the historical picture quality evaluation result in the historical bitrate regulation period comprises:
determining a video frame picture quality fluctuation degree based on a standard deviation between the current picture quality evaluation result and the historical picture quality evaluation result; and
determining, according to the video frame picture quality fluctuation degree, a target bitrate of a next bitrate regulation period adjacent to the current bitrate regulation period based on the current bitrate.

13. The device of claim 12, wherein in response to the current bitrate being a bitrate value that has undergone a bitrate reduction, determining, according to the video frame picture quality fluctuation degree, a target bitrate of a next bitrate regulation period adjacent to the current bitrate regulation period based on the current bitrate comprises:
matching a target bitrate regulation amplitude based on the video frame picture quality fluctuation degree; and
performing a bitrate callback on the current bitrate based on the target bitrate regulation amplitude, to determine a target bitrate of the next bitrate regulation period adjacent to the current bitrate regulation period.

14. The device of claim 9, the acts further comprising:
in accordance with a determination that the current bitrate is a bitrate upper limit value in a predetermined bit-table and a network state satisfies a predetermined high-quality network evaluation standard, comparing the current picture quality evaluation result with a predetermined target picture quality reference interval; and
in accordance with a determination that the current picture quality evaluation result is lower than a lower limit of the predetermined target picture quality reference interval, adjusting the bitrate upper limit value.

15. The device of claim 14, wherein adjusting the bitrate upper limit value comprises:
determining a bitrate adjustment scale factor based on a ratio of a current average bandwidth estimation value to the bitrate upper limit value; and
determining and adjusting to obtain a new bitrate upper limit value based on the bitrate adjustment scale factor and the bitrate upper limit value.

16. The device of claim 9, the acts further comprising:
detecting a fluctuation state of a network bandwidth in a predetermined time window before starting a bitrate regulation period; and
determining whether the fluctuation state of the network bandwidth satisfies a predetermined bitrate regulation period starting standard adapted to a plurality of transmission protocols simultaneously.

17. A non-transitory computer-readable storage medium having a computer program stored thereon, wherein the computer program, when executed by a processor, implements acts of video bitrate adjustment, the acts comprising:
analyzing and determining, based on a video frame, a current picture quality evaluation result of a target video stream in a current bitrate regulation period; and
determining a target bitrate based on a predetermined target picture quality evaluation standard associated with a bitrate and/or a picture quality change trend of the current picture quality evaluation result relative to a historical picture quality evaluation result in a historical bitrate regulation period.

18. The medium of claim 17, wherein analyzing and determining, based on the video frame, the current picture quality evaluation result of the target video stream in the current bitrate regulation period comprises:
determining, based on each pre-encoded video frame and a corresponding post-encoded video frame of the target video stream, a predetermined picture quality evaluation parameter of each video frame in the current bitrate regulation period; and
performing time domain pooling processing on the predetermined picture quality evaluation parameter of each video frame, to obtain the current picture quality evaluation result.

19. The medium of claim 17, wherein determining the target bitrate based on the predetermined target picture quality evaluation standard associated with the bitrate comprises:
determining whether a difference between the current picture quality evaluation result and a predetermined target picture quality evaluation standard corresponding to a current bitrate is within a range of a predetermined picture quality control error; and
in response to the difference between the current picture quality evaluation result and the predetermined target picture quality evaluation standard corresponding to the current bitrate being greater than the predetermined picture quality control error, adjusting the current bitrate based on a predetermined bitrate adjustment step to determine the target bitrate.

20. The medium of claim 17, wherein determining the target bitrate based on the picture quality change trend of the current picture quality evaluation result relative to the historical picture quality evaluation result in the historical bitrate regulation period comprises:
determining a video frame picture quality fluctuation degree based on a standard deviation between the current picture quality evaluation result and the historical picture quality evaluation result; and
determining, according to the video frame picture quality fluctuation degree, a target bitrate of a next bitrate regulation period adjacent to the current bitrate regulation period based on the current bitrate.
